(19) United States
(12) Patent Application Publication
(10) Pub. No.: US 2011/0258128 A1
(43) Pub. Date: Oct. 20, 2011

(54) RECYCLE PROGRAM

(76) Inventors: Frederick H. Hambleton, Orchard Lake, MI (US); Alfred Nelson Gatt, JR., Lake Orion, MI (US); Michael E. Eichhorn, Davison, MI (US); Bernhard C. Rumbold, Clarkston, MI (US)

(21) Appl. No.: 12/901,604

(22) Filed: Oct. 11, 2010

Related U.S. Application Data
(60) Provisional application No. 61/324,846, filed on Apr. 16, 2010.

(51) Int. Cl. G06Q 50/00; G06Q 30/00

(52) U.S. Cl. 705/308

(57) ABSTRACT

A system and method for automating the activities associated with a recycling program and to improve recycling participation. The recycling program adapts social science principles to significantly increase long term participating rates in the recycling activities by promoting positive behavioral changes to encourage higher participation in the recycling program by implementing group dynamic features relating to group decision making. One aspect of the invention is that it provides financial incentives in the form of rewards coupons to anyone engaged in recycling through a Rewards for Recycling Community Club and the coupons are redeemable at participating merchants who contribute the rewards coupons as members of the community recycling club.

### CROSS-REFERENCE TO RELATED APPLICATIONS

This application is a continuation-in-part of U.S. Provisional Patent Application Ser. No. 61/324,846, filed on Apr. 16, 2010.

### STATEMENT REGARDING FEDERALLY SPONSORED RESEARCH

Not applicable.

### REFERENCE TO SEQUENCE LISTING

Not applicable.

### BACKGROUND OF THE INVENTION

1. Field of the Invention

The invention is generally directed to methods and systems to improve recycling participation by utilizing a community-based recycling program that promotes positive behavioral changes and results in higher participation rates in recycling programs than those that are currently being obtained. The community-based program provides rewards to encourage both increased and continuing participation in curbside recycling programs. More specifically, the invention is a method of increasing participation of a community-based recycling program by utilizing group dynamics to impact upon each of the individual group member's decision making as it relates to environmental issues. By assembling individual recyclers into a communal group it is possible to significantly impact the extent of each individual's participation in a new or existing community-based residential recycling program.

2. Description of the Prior Art

Historically, recycling has been practiced for hundreds of years in various parts of the world. During World War II, massive government promotion campaigns, in every country involved in the war, were carried out to urge citizens that they had a patriotic duty to conserve certain materials. Interest in recycling accelerated dramatically in the early 1970s as a result of rapidly rising energy costs. This energy “crisis” made people more aware of the energy trapped in general household waste and the energy savings that could be made if everyday materials were recycled instead of being discarded in a landfill. Legislation was used to create an initial supply of recyclable materials through the use of mandatory recycling, the passage of container deposit legislation as well as the use of refuse bans, and legislation has also been used to increase and maintain a demand for recycled materials. For example, minimum recycled content mandates, utilization rates, procurement policies, and recycled product labeling are the various methods used by governments to maintain and increase demands for recycling. Government purchasing power is also used to increase demands for recycling by requiring procurement policies that earmark a certain amount of spending solely on recycled products. Government regulation, such as product labeling also allows consumers to make more educated choices when they purchase products made partially or wholly with recycled materials which indirectly results in an increase in the demands for recycled materials.

Because of these various incentives to increase the supply of recyclable materials, the industry has gradually developed high technology automated equipment for the collection, sorting, and recovery of recyclable materials. During the same period of time, interest in curbside recycling, by the general population in the United States, has grown and integrated recycling programs have been started in both large cities and small communities. Unfortunately, the results from such programs have been disappointing; therefore, most recycling programs are continually searching for ways to increase participation and thereby improve the effectiveness of their recycling programs.

Initial social science research into human behavior discovered that certain factors influence people's daily habits. Results of this research indicated that people are motivated to change their behavior by the actual pressure they receive from family and friends to do so. For example, simply knowing that family, friends, and neighbors recycle increases an individual's likelihood to recycle. Providing feedback on community recycling rates gives community residents information about the extent to which other community members are participating in recycling. Also, people's knowledge of how and/or what to recycle is directly linked to their level of participation. Therefore, it is essential to provide access to recycling information such as the types of materials that are acceptable, what products are made from recyclables, how to prepare materials for your recycling container and how much money recycling can save.

An analysis of existing behavioral research data indicates that providing information alone is not enough to change behavior in the majority of a given population. However, by combining effective communication of information with behavior changing devices such as prompts, commitment techniques, and long-term incentives, communities can improve the chances that recycling information will be absorbed and acted upon. Short-term monetary incentives, such as lotteries that reward a random recycler for his/her efforts do not produce lasting behavior as rates return to their prior levels when the incentives are no longer available. Several attempts have been made in the past to provide incentives for recycling for individuals.

Japanese Laid Open Patent Applications 2002-2978740 (2001) and 2005-008339 (2003) are typical of those programs that measure an individual's recycling behavior and through an integrated record keeping system, provide incentives for such individual in an attempt to increase recycling participation. Unfortunately, merely creating incentives will likely encourage users to try and recycle goods that are not fit for processing in order to retain rewards or other benefits. Particularly, if the quality of recyclable materials is measured by mass quantity only, there is a great incentive for users to add heavy, low-quality or non-recyclable materials to the recycling stream in order to obtain greater benefits.

Casella, U.S. Patent Publication No. 2007/0260466, also discloses a typical recycling system for individual users, which includes means and steps for receiving and measuring waste material from each user, receiving and measuring recyclable materials from each user, measuring a quantity of each type of material, and calculating an individual user-specific diversion rate based upon the ratio of recyclable materials as compared to the sum of the recyclable and waste materials. The collection and measurement process is carried out by a plurality of collection vehicles and/or trucks, which network with a central computer and a series of material recovery facilities. After which the user-specific diversion rates are recalculated based upon the ratio of the weight of the recyclable materials to the weight of both the recyclable and the residual waste materials. Then a plurality of quality-material reports are derived from the stored data by relating the quantity of recyclable materials to the quantity of waste materials received from each individual user in an attempt to influence the user-specific diversion rate and thus create an incentive to recycle. The recycling program includes a system and method for providing incentives for recycling by rewarding each individual in proportion to their own particular internal household diversion rate. A number of benefits are provided ranging from economic rewards to coupons for commercial entities, all of which attempt to provide a greater incentive for recycling.

Fitzgerald, U.S. Patent Publication No. 2006-0178933, like Casella also attempts to improve participation rates by providing financial incentives to individual households that are engaged in recycling. This is accomplished by tracking and analyzing tonnage and participation at the individual household level in order to design and implement effective strategies to increase recycling. This data acquisition and analysis method enables officials to recognize and address trends on both micro and macro levels. Fitzgerald proposes that by accurately providing data describing the effectiveness of recycling programs, e.g., by optimizing the route collection system, by matching tonnage collected with truck capacities, by determining participation rates for each collection route, then analyzing this data, the overall efficiency of the recycle program may be improved. Further, the data managing system can produce such information as geographic analysis which analyze the distribution of recycling patterns for respective households; an historical analysis for investigating temporal recycling trends for one or more respective households; route analysis for analyzing recycling statistics for each recycling collection vehicle; route optimization for predicting an optimal recycling route; compliance determination which evaluates the statistical likelihood of a specific household complying with recycling requirements; and like Casella, an incentive response procedure for determining how each individual household responds to various recycling incentives.

Although initial social science research programs on recycling behavior discovered that providing feedback on community recycling rates by providing residents information about the extent to which other community members are participating in recycling is a factor that influences any one individual's recycling habit, Casella's or Fitzgerald's data management systems fail to address the social and behavioral factors that collectively influence people's recycling habits.

As the basis for their existence, most prior art programs provide for a contractual agreement between a governmental authority and a service provider, whereby the contractor provides the recycling program as an auxiliary service to the main household waste collection program. In general, this type of program requires that each resident open an account with the contractor before they can participate in the recycling program. Again, some form of incentive is provided when an individual activates a new account and become a participant in the program. Until this procedure has been completed individual residents are not engaged in the program and they are unable to redeem any rewards. In other words, registration must be completed before an individual curbside recycler can become a member of their own recycling community. Furthermore, none of these prior art recycling programs or systems have given any consideration to the behavioral changes that an individual may have to make before they can commit to becoming an active participant in the communities recycling program.

Therefore, what is needed is a recycling system or program that not only provides the data management activities associated with the collection of recyclables, but incorporates methods and techniques that elicit positive behavioral changes in the participants, which will lead to participation rates that are significantly higher than those obtained with current programs.

### SUMMARY OF THE INVENTION

The invention is a recycling program that takes into consideration the mental processes that shape an individual's choices, behaviors, and attitudes. It considers how these behavioral factors apply to the study of recycling behavior and practice, and how they provide an insight into how such factors influence an individual's decision whether or not to participate in a communal recycling program.

Increasing participation in a recycling program will require a majority of the new members to make significant change to their normal behavior patterns along with other adjustments to their normal lifestyle. According to Icek Ajzon's Theory of Planned Behavior (1991), human behavior is guided by three types of consideration: there are beliefs about the likely outcome or consequences of the behavior and an evaluation of these outcomes (behavior beliefs); there are beliefs about the normative expectations of others and one's motivation to comply with these expectations (normative beliefs); and beliefs about the presence of external factors that may facilitate or impede performance of the behavior and the perceived power of these factors (control beliefs). Behavior beliefs lead to a positive or negative attitude towards a specific type of behavior, while normative beliefs, or the expectations of others, provide social and subjective norms, and control beliefs give rise to perceived behavioral control that is due to external factors such as social and moral values. Within a given decision making scenario, a combination of individual behavioral beliefs, the response to subjective norms and the influence of control beliefs will lead to a specific behavioral intention for that specific situation. It has been shown that the best way to minimize the influence of behavioral beliefs and maximize the influence of normative and societal control beliefs is to make decisions as a group. This concept of human behaviour has been used to explain the success of group therapy in addressing intractable personal problems such as drug and alcohol addiction.

Kahneman and Tversky have shown that Individuals can behave unexpectedly and irrationally when confronted with the simplest of choices. For example, we are more averse to suffering a loss than we are interested in making a gain and we often make decisions using snap judgments rather than rational analysis. Therefore, it is important to frame a long-term lifestyle decision, such as joining a recycling program, in its proper context, or most people will make the easy decision and opt out. Here again it has been shown that if you want to obtain an affirmative decision about an issue that requires making a long term commitment, it is best made in a group environment, where normative and societal beliefs can override our personal behavioral beliefs.

Although external factors have an influence on behavior, it is ultimately each individual's motivation and their ability to commit to changing their lifestyle that will determine their recycling behavior. The study of environmental psychology shows the direct correlation that the surrounding physical environment and stimuli have on an individual's action and the physical environment in which an individual resides has a substantial impact on an individual's behavior and motivation. For example, the recycling rate in affluent communities is higher than it is in communities where people live under much more difficult economic circumstances.

In order to attempt to gain some understanding as to why changing human behavior is important from an environmental viewpoint it is noted that science tells us that almost all environmental problems are caused by human behavior. Therefore, it would seem reasonable to assume that these problems can only be addressed by changing or modifying such behavior. To consider how change comes about, it is first necessary to look at how humans perceive and deal with risk, because people in general regard making a change as a risk they would rather avoid, if at all possible. Our brain processes risk in one of two ways: either analytically or emotionally. In the analytical mode we take into consideration costs and compare them to some perceived benefit and try to weigh one against the other. In the emotional mode we experience risk as a primitive feeling, such as when we wake up and smell smoke and immediately recognize the risk of fire. Unfortunately there are some undesirable implications to both of these risk assessment procedures.

When we evaluate issues using our analytical mode, we are not very good at evaluating long-term risk factors and in addition, we have a built-in dislike for delayed benefits. Therefore, this risk assessment mode makes it difficult to get people to make lifestyle changes if the intention is to make the world a better place in twenty years time. On the emotional side, our risk evaluation system has developed in a way that allows us to set aside any concerns we have about a dangerous situation that is not close to immediate on a perceived time scale. Therefore, the accumulation of carbon dioxide in the atmosphere, which may produce drastic changes in our climate and raise sea levels dramatically within fifty years, is not perceived as dangerous and relegated to the back of the mind.

To further compound our inclination to “put off any long term decisions until tomorrow”, people have what behavioral scientists call a “finite pool of worry,” meaning that individuals are unable to maintain their concern about a long-term problem if a different problem, such as a plunging stock market, depleting retirement funds, or a personal emergency comes along and fills up our “worry pool”. Because of this “finite pool of worry” we tend to move one fear out of our worry bin before we can move another one in. Even if we were able to remain consistently concerned about a warming world (single action basis) we tend to resolve such distressing issues by buying a more efficient furnace, adding additional insulation to the attic, or vote for a green candidate.

How then do we get people to focus on a long-term environmental program, such as residential waste recycling, when they have bigger and more important short term problems to worry about.

The Center for Research on Environmental Decisions (CRED) at Columbia University Behavioral Laboratories has studied how group dynamics shape environmental decisions and how groups of people are better able to set aside the perceived risk that comes with changing an accepted practice. The behavioral scientists at CRED have discovered that group dynamics has a significant impact on how our mind works and how working in a group allows individuals to resolve the differences between their analytical and emotional risk assessment procedures. In group decision making units, individuals maneuvered between analytical thinking and emotional feeling to arrive at environmentally sound consensual decisions by soothing individuals worries, by explaining technical information to one another, or by appealing to the group's more courageous instincts.

From these experiments, it was quickly recognized that being a member of a group is a pleasurable experience for the individual members because they recognize that they were a part of a truly effective decision making unit. In a group environment most of the decision making conversation included subtle markers of inclusion, such as “us” and “we”. However, if the same decisions were first considered individually and then everyone met as a group, these inclusive markers were much less common and consensual decision making was much more difficult. In addition, the researchers at CRED have found that a group is much better than a set of individuals when it comes to finding a way to implement an environmental project in which the realizable benefit is subject to a long-term delay.

Accordingly, the invention is generally directed to methods and systems for improving recycling by creating programs that are group oriented. Any features in the program foster an element of individual competition, or provide special benefits to one or more individuals are eliminated. The invention operates on the premise that recycling is a communal effort and it should never be a competition to see who can set out the most recyclable material. Indeed, one of the programs most basic premises is that people who do not recycle are still members of the program and thus able to claim some of the benefits associated with such membership. In general, the invention is practiced by obtaining a contract from a municipal community with a waste collection system that includes a recycling program. Concurrent with the execution of the contract there is formed a group recycling program or club for that community. Upon execution of such a contract, every single individual and or entity within the community becomes a member of a Rewards for Recycling Club that is dedicated to that community and to promoting and improving the recycling program that is already in place. In other words, each individual and or entity within the municipality is automatically recognized as a recycler and need not apply for membership because if he/she resides within the geographical limits of the municipality, he/she acquired automatic membership into the community recycling club due to the fact that the municipality has, as a group unit, contracted to promote their community recycling program. The new community recycling club that is created is named for the community it is designed to serve, but is generically referred to as a Rewards for Recycling Community Club (RFRCC). A typical example would be The Davison Township Rewards for Recycling Club, which services the community of Davison Township in Michigan.

As soon as the basic contract with the municipality is in place, the specific goals of the RFRCC are promoted in the local media in a manner that begins to build an awareness of the Rewards for Recycling Community Club and its goals and aspirations within the community. In this way, the individual members of the RFRCC are co-opted into a group environment, that is, their Rewards for Recycling Community Club before all the details of the program are actually released to them. This procedure is based upon behavioral studies at CRED, which have demonstrated when an environmental decision is first considered by a group, rather than by a set of individuals, their commitment to a long term program, such as a community wide recycling project, is much more focused and the results are much better.

The ongoing television and web marketing program associated with the RFRCC allows the RFRCC to continuously build momentum within the residential membership section, while a group of local community merchants is assembled to supply “Rewards” to all the RFRCC members. The rewards are posted on the RFRCC website, where a portion is designated as “Tier 1 Rewards” and these rewards are available to every member of the RFRCC. The balance is designated as “Tier 2 Rewards” and these “Rewards” may only be redeemed by members that are designated as “active recyclers” (defined hereinafter). Any RFRCC member may sign-up to obtain rewards by visiting the Rewards for Recycling website and completing a simple login procedure or by calling their local Rewards for Recycling office, or a local RFRCC official, who will then forward their information to the appropriate Rewards for Recycling club.

Once the television and web-based marketing programs have built awareness of the program within the community, a direct mail package containing more detailed information about the local RFRCC is mailed to every residential address in the community. This package contains details of their RFRCC's rewards program together with an identification sticker that the members attach to their recycling container. In the case where member participation is measured directly, the identification sticker is a radio frequency identification device, commonly known as an RFID tag. In this case, the RFID tags are alphanumerically coded to specifically identify the name of the local RFRCC and the specific mailing address that the tag was sent to. For example, the alpha code for the Davison Township club is DAV, followed by the six digits that are used to define each address within the Davison community.

The mailed instructions request that the recipient attach the member identification tag to their recycling container(s), where it is used to determine the addresses at which recyclable materials are set out on a regular basis. The residents living at the addresses that regularly set out recycling containers are designated as “active recyclers” within the RFRCC database, which allows them to redeem the more valuable Tier 2 Rewards. At that point, the RFRCC's member database consists of two groups: the active recyclers who set out a recycling container on a periodic basis and those that do not. The members of this latter group are designated as “inactive recyclers” as they are paying for a recycling service but they choose not to use it. One of the main focuses of the Rewards for Recycling program is to identify these inactive users and reach out to them in as many ways as possible, so as to have them transition to the active recycling group. This process is supported by several behavioral studies at CRED and other research centers and in some cases, the transitional process involves using the subgroups within the RFRCC that help inactive recyclers understand the benefits of the RFRCC program from both a social and economic point of view.

In behavioral science, this type of focused communication is often referred to as placing a decision process within its proper frame. In general, it is referred to as “framing,” that is, reaching out to decision makers when they are in a group situation where they feel comfortable, then moving or “nudging” them into a decision such as joining the RFRCC's recycling program. Typical examples are churches, political associations, schools, and athletic clubs. However, there is almost no limit to the number of ways in which an argument to join the active recycling section of an RFRCC can be presented or “framed” to the inactive recycling members. For example, a member of a church group who is an active member of the RFRCC can nudge members that are inactive recyclers into building the membership on the active side of their communities RFRCC program.

A good description of this type of decision-making process has been provided by Thaler and Sunsteen in their book, “Nudges: Improving Decisions about Health Wealth and Happiness”. The book describes how frames and nudges are just messages that resonate with a particular audience or take advantage of cognitive biases that certain groups of people have. In an ideal case, per Thaler and Sunstein, such techniques are used to gently direct us towards actions that are in our best long-term best interests, such as joining an automatic retirement savings program, which overcomes the natural inertia preventing us from setting aside regular sums of money ourself. They also explain that making feedback available through technology, such as an RFRCC website, will appeal to our desire for short term satisfaction and they also state that being “rewarded” for committing to a long-term decision is another powerful motivator.

The Rewards for Recycling (R4R) website in conjunction with all the data that is stored in the user database is central in the process of persuading inactive recyclers to join the active part of the recycling program. As data is accumulated, it is possible to define the active and inactive users in many different ways and then use this data together with the connections and frames it provides, to create a variety of nudges, such as donate your rewards to persuade inactive members to become active recyclers. In some cases, these connections can be established through contacts or groups in the merchant community or by using the sponsors of the RFRCC programs, to provide special incentives or rewards to newly active recyclers. When these procedures are used to promote recycling activity within an individual or group of RFRCC's the change in participation can increase dramatically and some examples are provided below.

Results from programs that have been utilizing the RFRCC program have shown that the total number of individuals requesting a recycle container has increased to approximately 60%-65% of the total residential population. Whereas, community wide municipal recycling programs that do not utilize incentive based programs generally have a participation rate that include 18% to 25% of the residences. If we examine some other prior art rewards oriented recycling programs, they initially experience participation rates as high as 60%, but this initial response rate tends to deteriorate to approximately 25% over the long term.

In general, the prior art rewards oriented recycling programs have been directed towards improving the rate of individual participation whereby rewards are allocated in direct proportion to the amount of material each participant recycles. These programs do not attempt to distinguish between recyclers and non-recyclers and make no attempt to convert non-recycling households into ones that do recycle. In essence, a rewards for recycling program adapts a co-operative approach, which requires an understanding of human decision making and how the decision making process will differ when an individual's choice is constrained by direct and indirect peer pressure from the active members of a group, that is, their RFRCC.

A Rewards for Recycling Community Club (RFRCC), as proposed in this invention, was introduced into a community that had been operating a community wide recycling program for many years before committing to the RFRCC model. Prior to signing a contract with Rewards for Recycling, the average residential participation level was 22% and the amount of material diverted into a recycling stream was about 6% of the total waste generated. The community was prepared for the change to the RFRCC program by several weeks of television advertising and a concentrated effort to have residents sign up as recyclers on the RFRCC website. At that point, the descriptive brochures were mailed to each home and the local waste collection contractor agreed to collect RFID data to determine the set out rates. The contractor, who had been collecting recyclables in the community for a number of years, had detailed historical information as to the number of homes that set out recycling containers, plus the gross weight of recyclables that had been collected. The residential participation rate, after the first three months of the RFRCC program, rose to over 50% of the residential homes in the community, while the gross weight of the material collected almost doubled. The participation has continued to increase and it presently stands at 67% and it is still rising. The waste collection contractor has reported that the amount of recycled material they collected has increased by more than 300% and it now accounts for more 20% of the total residential waste stream. In some RFRCC communities, the waste hauler has been able to eliminate one or more trash collection trucks and replace them with an equivalent number of recycling trucks. Of all of the communities participating in the invention today, there has not been one where participation rates have reduced since the RFRCC program was started.

Communities, as recited herein, need not be only municipal bodies. For example, a community may be a condominium association, an apartment complex, or a homeowner's association. In fact, it may be a group of identified individuals who are individually active recyclers or environmental activists who strongly believe that recycling will help to provide for a better environment both now and in the future. Also, a community may be defined as a geographically designated group or a politically oriented group; the objective being to create a group that becomes the central decision making unit for the individual members of the recycling program.

The RFRCC also uses an incentive oriented approach to recycling but it is not based on the weight of recyclables collected or a specific diversion rate as practiced in the prior art recycling programs. Every RFRCC member has access to the rewards but access to the more valuable ones is based solely on whether you are an active recycler or not. If an RFRCC member records a recycling event at least once per month, the member is deemed to be an active recycler with access to both the Tier 1 and Tier 2 reward levels. In addition, active recyclers automatically qualify for a chance to win a special Tier 3 reward, which is a high value prize that is awarded on a periodic basis. It is extensively publicized through television advertising, and on the central Rewards for Recycling website, and then it is awarded to a specific RFRCC member, or to a participating member of the public. If a member does not record any recycling event within a specific time period which is defined by their RFRCC, they are deemed to be an inactive recycler. As such, they are restricted to claiming just Tier 1 rewards on the RFRCC website and they do not qualify for the Tier 3 high value prize.

In conjunction with the concept of structuring a recycling community club where only group participation preferences are adapted, the subject invention also is directed to a system and method for measuring and managing the individual user participation and activities of each RFRCC as it relates to recycling activities such as reporting recycling events, redeeming rewards, participating in prize selection activities, and defining inactive recyclers within each RFRCC unit over a distributed computer network (DCN).

In particular, the system and method provides for storing data related to and coordinating the multitude of tasks associated with the variety of individual activities of each member of a defined RFRCC user group. This data is stored in a relational database.

The method includes the steps of generating a user record including data entry fields for entering a recycling event, tracking continuing recycling events, defining active and inactive recyclers, summarizing the rewards retrieved for each user, which group of rewards, by classification, most frequently selected, providing merchants access to user redemption information, and any number of other relational classes of information.

In still another method, the steps include generating a web-based customer record, including data entry fields, for entering a recycling event over the world wide web, measuring and managing the individual user participation and activities of a defined RFRCC group as they relate to recycling activities, such as reporting a recycling event, overseeing prize selections, recording redemptions, defining inactive recyclers within a community unit, providing an RFRCC with access to the individual customer record over the world wide web, and through a server based application, to facilitate entry of the various customer activities in appropriate fields of the customer record.

In yet another embodiment of the invention, the method steps includes tracking a series of activities or tasks related to recording recycling events for the active recyclers. Schedules must be developed to define a timetable for recyclers and for the collection of data evidencing a recycling event. These schedules are typically different for the collection of data from a municipal or a subdivision unit as compared to a group of individual recyclers. The schedules used in the transaction process can be contingent on such factors as geographical location, political affiliation, event logging procedures, or many other types of group constraints and preferences. Transaction tracking of a recycling event is an activity only used and practiced by an RFRCC, and the transactional database does not provide users or merchants with direct access to the user-reward database for the reason that transaction tracking is the sole responsibility of the RFRCC and the Rewards for Recycling office that oversees that particular RFRCC.

The transaction tracking relational database can also be used to store a further embodiment of the invention which includes web and television marketing and promotion activities together with the associated subsections. Again, such activity is the sole responsibility of RFRCC and therefore, these systems are utilized solely by the RFRCC to build and assemble the user member groups as well as the merchant member groups. Television promotional spots are scheduled and used to attract both individual members and new communities into using an RFRCC program. In addition, the television advertisements, together with web promotions on the RFRCC website, are used to enlist local merchants into the RFRCC program as shown schematically in FIG. 1 of the drawings. The merchants pay a fee to place short promotions in the regular RFRCC television spots and they may also utilize the RFRCC website to promote their business through the provision of reward coupons or the direct placements of advertisements on the website itself. In most case, transaction tracking is accomplished over a DCN, which can be accessed over a local or wide area network, wireless devices, computers, telephones and other handheld devices such as personal digital assistants.

Automated notifications allow all parties having access to the transaction tracking process to be kept informed of relevant information. For example, notification is initiated when certain specific rewards are temporarily unavailable; when specific members of an RFRCC are sent pre-selected promotional material, because user information indicates a reduction of recycling events in their RFRCC; when it is scheduling a Tier 3 prize event, or whenever an RFRCC, or a specific group of members within an RFRCC, need to be reminded or incentivized to generate a specific action or reaction.

A further embodiment of the invention is the merchant's database, which contains the information about each merchant participating in the RFRCC program. Typical data entries are name, address, business classification, community base, the merchant group if one has been formed, coupons issued, coupons claimed, coupon redeemed, with date and time stamp, total number of coupons redeemed, date for each member claiming each coupon, and a reference number to relate this information to other database demographic information. Further, the data includes references to merchants that purchase TV time for ads, and other RFRCC advertising opportunities. The merchant administration system gives merchants the ability to provide updated coupons for the Tier 1 and Tier 2 coupon sites, as well as obtain feedback, from the Rewards for Recycling office that manages that particular RFRCC, with regard to the coupon usage by the users. Before a merchant may post a coupon on an RFRCC rewards site it must first be approved by Rewards for Recycling for form, look and content. The merchant database aggregates the value of all the rewards that are redeemed on each RFRCC, so as to demonstrate to the decision makers overseeing an RFRCC, the actual value of all the rewards, delivered to the members of each community group that uses a specific RFRCC program. This allows the decision makers to pass this information along to all their group members and to use the cost savings to encourage the inactive members of the RFRCC to become active participants in the program.

Reminders are dispensed over the network to expose the active users to a variety of changes and updates that are added on an ongoing basis to each RFRCC program. In addition reminders are also extensively used to nudge the inactive recyclers into changing their habits and become active recyclers, while further nudges are used to remind active recyclers to maintain their commitment and to keep up the habit of recycling.

For reminders, an automated system of notification is provided for both the active and inactive users, although different information may be sent to each group, or sub-group. Notification can take place via a variety of different methods which include but are not limited to television or website reminders, internet social networks such as Facebook and Twitter, and customized email and text-messages to wireless devices, computers, and hand-held devices such as telephones or personal digital assistants.

Users can elect to be notified via an automated process in addition to accessing their reminders via email, although a variety of methods may be used as would be appreciated by those skilled in the art.

These and other aspects of the system and method of the subject invention and the method of using the same will become more readily apparent to those having ordinary skill in the art from the following detailed description of the invention taken in conjunction with the drawings described herein below.

### BRIEF DESCRIPTION OF THE SEVERAL VIEWS OF THE DRAWINGS

Features and advantages of the present invention will become apparent to those skilled in the art from the following description with reference to the drawings, in which:

FIG. 1 is a diagrammatic representation of the implementation of group dynamic features discovered from decision making theory into a Rewards for Recycling Community Club constructed in accordance with the various embodiment(s) of the present invention;

FIG. 2 is a diagrammatic representation of a typical multi-tiered distribution computer network (DCN) system according to the embodiment of the present invention; and

FIG. 3 is a diagrammatic representation overview of a typical distributed computer network (DCN) system environment according to an embodiment of the present invention;

### DETAILED DESCRIPTION OF THE PREFERRED EMBODIMENT

The present invention provides a system and method for managing a community recycling program with particular emphasis on increasing participation of a community based recycling program by implementing the theory of group dynamics, in particular, how an individual's decision to participate in a community recycling program is influenced by their being a member of the RFRCC group.

The invention is a community based recycling program entitled Rewards for Recycling Community Club (RFRCC) that takes into consideration the mental processes that shape a person's choices, behaviors, and attitudes. In particular, how they apply to the study of recycling behavior and how such factors influence that persons decision to either participate or not.

The ultimate objective being to make efficacious use of the decisions made by individual members of a recycling program by utilizing principles derived from behavioral science and decision making research, and thereby obtain a significant beneficial increase in overall participation in such recycling activities. The behavioral scientists at Center for Research on Environmental Decisions CRED have discovered that group dynamics have a significant impact on how our mind works and how working in a group allows individuals to rationalize the tussle between their analytical and emotional risk assessment procedures. In group decision making units, individuals maneuvered between analytical thinking and emotional feeling to arrive at an environmentally sound consensual decisions by soothing individuals worries, by explaining technical information to one another, or by appealing to the group's more courageous instincts.

From these experiments, it was quickly recognized that being a member of a group was a pleasurable experience for the individual members because they recognized that they were a part of a truly effective decision making unit. In a group environment, most of the decision making conversation included subtle markers of inclusion such as “us” and “we”. However, if the same decisions were first considered individually and then everyone met as a group, these inclusive markers were much less common and consensual decision making was much more difficult. In addition, the researchers at CRED have found that groups are much better than individuals when it comes to finding a way to implement environmental projects in which the participants understand that the realizable benefits are deferred well into the distant future.

In general, the present invention provides a system and method for remotely managing one or more recycling programs, in the form of one or more RFRCC organizations, using a network of databases and a set of associated event logging systems. The computer system, together with its associated data entry and management systems, allows the administrators at the Rewards for Recycling Central Management Office (RFRMO) to manage and promote recycling activities that take place within the various RFRCC organizations. It additionally allows employees and/or agents working for the RFRMO to collect, process, and control data and documents, i.e. reports relating to the recycling activities, in an efficient, cost-effective manner. It further allows both active and inactive recyclers, as user members of a defined RFRCC, as well as merchant members of the RFRCC, using the recycling program, to have role-based access to specific transactions, or portions of the databases that are a part thereof.

In accordance with a preferred embodiment of the present invention, different participants of the system perform different functions depending on their role. For example, administrators manage, maintain, and monitor information in the system related to their specific RFRCC programs, which may involve one or more Rewards for Recycling Management Office (RFRMO) locations. Employees at the RFRCC create user group listings (aka community club or community group records), maintain user lists, monitor and enter information related to the recycling activities and related rewards, and maintain and control access to the community club records. Administrators are also agents, and can act in every way as an agent. Administrative employees (staff) assist by entering data into the system and by other clerical efforts. Likewise, agent assistants do similar clerical work for agents.

Within an individual or group of RFRCC organizations, the individual users, or members, of each RFRCC that commit to recycling (the active recyclers) can access data from the system that is related to their recycling activities and claim a variety of Tier 1 and Tier 2 rewards. In the same way merchants that provide the rewards can enter and access data for listings to which they have been granted access. In the alternative, those users or members that do not recycle, that is, the inactive recyclers may visit the site to claim just Tier 1 rewards. Once they are on the site they will be exposed to the more valuable Tier 2 and Tier 3 rewards that are only available to active recyclers. This together with other promotions is used to help persuade them to begin recycling a part of their own household waste.

It is envisioned that the preferred embodiment will exhibit a higher participation in recycling activities and be more user friendly as compared to prior art systems. Performance is based on how quickly data is selected, utilized and converted into a visually acceptable format that is available to the user. In the preferred embodiment, the networked computer system will provide acceptable performance through the use of adequate servers, proper indexing of data, proper bandwidth utilization, and optimized visual elements. The overall flexibility of the system allows for adaptation as certain business rules change. This is done through the use of stored procedures embedded in the relational databases that can be easily accessed and modified as required.

This is also accomplished by the use of specialized data structures within the present invention's databases. For example, ActiveX COM+ (component object model) elements that can be accessed by various applications, including without limitation, a system for maintaining recycling activities, together with associated internet and intranet applications. Maintainability encompasses ease of installation, deployment, and updates. It allows for people skilled in the art, other than the original development team, to easily perform modifications and enhancements to the system. In the preferred embodiment, the system is browser based and is maintained entirely on central servers, such that no updates need to be moved to the user's computer(s). Updates that have to be made on the server(s) can be accomplished via any type of network connection.

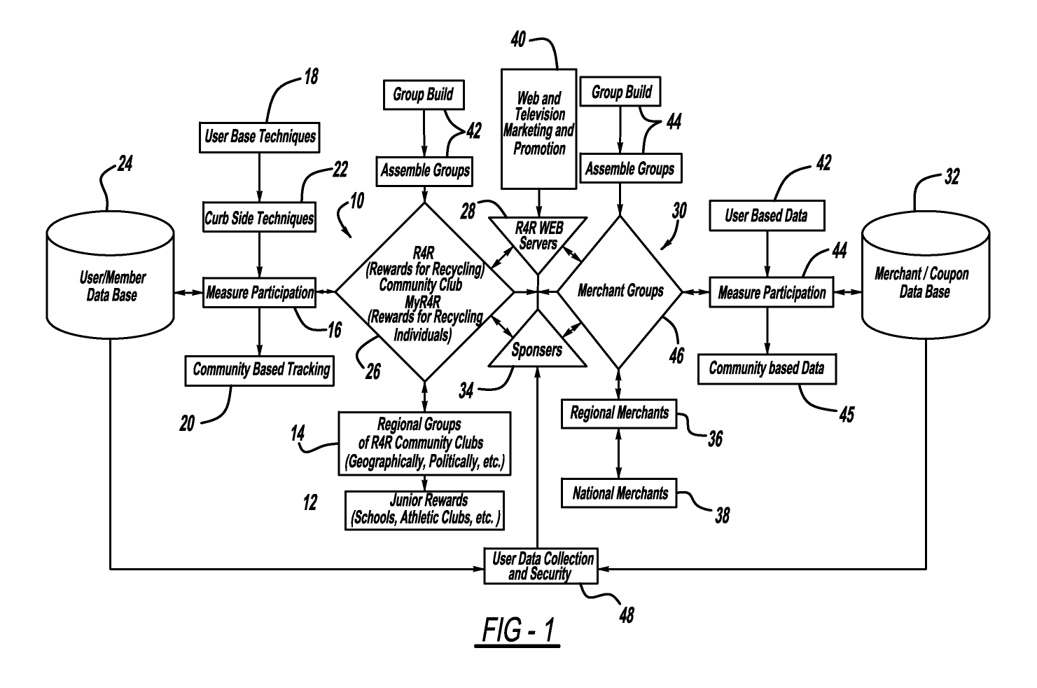

The description outlined below occasionally refers to certain specific drawing elements, within FIG. 1, 2, or 3 as indicated. However, the detailed descriptions may discuss the present invention without specific reference to any specific figure.

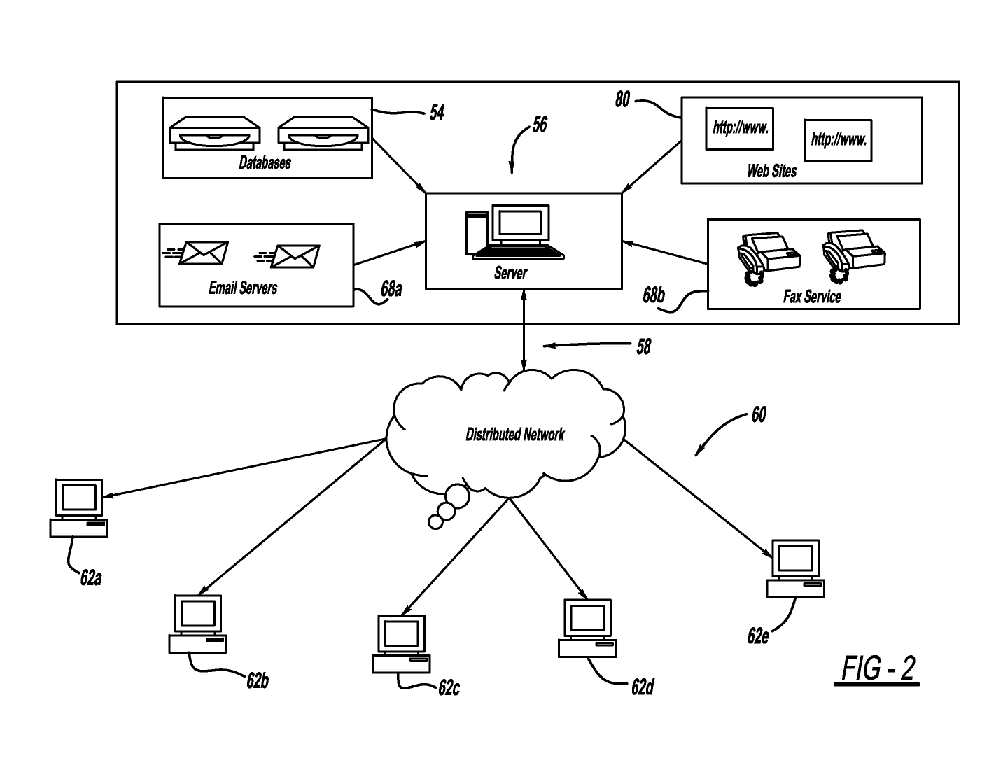

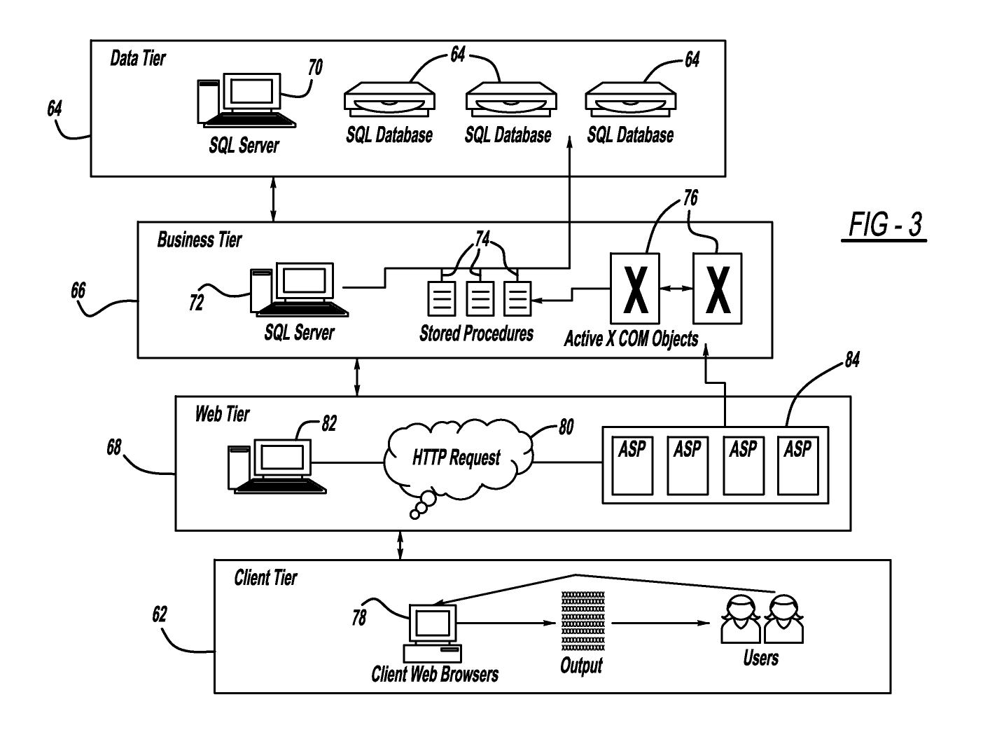

Referring now specifically to the drawing figures, FIG. 1 is a diagrammatic representation of the Rewards for Recycling Community Club constructed in accordance with the various embodiments of the present invention. FIGS. 2 and 3 concern the formation of a typical networked environment in which the system and method of invention may be implemented and will be discussed hereinafter.

Accordingly, with reference to FIG. 1, the invention is generally directed to methods and systems for improving recycling by execution of a contract with a municipal community or a waste hauler. The contract grants a license to practice the invention which begins with the formation of a defined group recycling program or an RFRCC, which by the execution of such a contract, automatically enrolls every single individual and/or entity residing in the community as a member of a defined recycling group or community recycling club, specifically referred to as an RFRCC 10.

Community, as used herein, need not be just a municipality, or other such similar governmental bodies. For example, a community may be a condominium association, an apartment complex, a school, or a homeowner's association 12. In fact, it may be any group of identified individuals who are individually active recyclers or environmental activists who strongly believe in recycling as a necessity towards a better future environment. Also, a community may be defined as a geographically designated group or a politically oriented group 14; the objective being to create a group unit such that the group becomes the decision making unit.

In general, the invention is practiced by obtaining a contract with a municipal community to acquire a license which grants them the right to set up a Rewards for Recycling Community Club or RFRCC in that community. Upon execution of such a contract, every single individual and or entity within the community becomes a member of the RFRCC that is dedicated to that community and to promoting and improving the recycling programs that may already be in place. In other words, each individual and or entity within the municipality is automatically recognized as a recycler and need not apply for membership because if he/she resides within the geographical limits of the municipality, automatic membership into the community recycling club is acquire by the fact that the municipality has, as a group unit, contracted to recycle.

Accordingly, the invention is generally directed to methods and systems for improving recycling participation by obtaining a contractual agreement with a municipal community for promoting the recycling activities that are generally a part of their ongoing waste collection program. In many cases, this is accomplished in conjunction with a waste hauler that has contracted with the municipality to collect and dispose of the waste and recyclables that are generated within the community. In such cases, the waste collection contractor may assume responsibility for determining the frequency at which residents in the community set out their recycling container(s). In this case, the hauler may also become a licensed user of the RFRCC 10, as shown in FIG. 1, and has use of the licensed technology in that particular community.

Any resident that logs a single recycling event within a fixed period of time, such as one month for example, is defined in the RFRCC database as an active recycler. The process of defining a recycling event is referred to as a recycling event logging (REL) procedure 16 and it is a vital part of the recycling system data collection program. As a corollary to this procedure, all of the other members who do not set out a recycling container do not generate an REL event and they are defined in the database as inactive recyclers.

In another method of implementing the program, the contract to license the RFRCC program from an RFRMO is put in place with the municipality directly. However in this case, the waste hauler, who has contracted with the municipality to collect and dispose of the waste and recyclables has declined to license the system and is not responsible for measuring community wide REL procedures. In this case, the event logging used to determine active recycling status may be carried out by RFRMO using a low or zero emissions vehicle such as a hybrid vehicle to determine recycling events within the community. An alternative method of logging recycling events in this type of community is to use a self-reporting system 18 whereby a resident is able to use several methods to report their recycling event to their local RFRMO. In such case, no external event logging procedure is required, although in most self-reporting RFRCC programs, the overall compliance level is audited by a third party.

Another method of implementing the program is to license the RFRCC program to the municipality with a provision that the municipality is responsible for determining and recording the occurrence of each individual recycling event within the community 20. In the case where a municipality operates its own waste collection and recycling program, within the purvey of a Department of Public Works, this department may assume responsibility for measuring and recording the recycling event log data that establishes which of their RFRCC members are active recyclers. As an alternative, the municipal or group authority may utilize the RFRMO event logging service or utilize one of the self-reporting systems that have been developed as a part of this invention.

Accordingly, a Rewards for Recycling Community Club (RFRCC), which is shown in its entirety in FIG. 1, can be implemented with any village, city, or county municipality. The recycling event data logging for the RFRCC 10 may be done in partnership with the community's new or existing waste hauler 22, in conjunction with RFRMO, directly by a municipal department 20, or indirectly by the RFRCC members themselves as a self-reporting community 18.

Upon reaching a final agreement to implement an RFRCC program, a list of residents, along with their addresses is obtained from the municipality or waste collection contractor and used to create a group membership list in the RFRCC user database 24. This list contains the name and address of the occupant of each individual residential dwelling within the defined group or community unit to which the contract pertains. Again, if such group is a condo association or apartment complex, the identity of each member, together with their specific address is provided, in list format, to the RFRCC. Then each member's name and address is entered into the user database 24.

In addition to this basic demographic information, each RFRCC member is assigned a user tag number, which in some cases may be an RFID data tag number. Thereafter this will act as a single unique identifier for every single entry in the user/member database. After a data tag number has been assigned to each entry in the RFRCC member database, the corresponding item is placed inside a mailing package that is sent out to each RFRCC member. This mailer also contains specific information about the program, together with instructions as to how the user tag number or RFID tag should be mounted on the member's primary recycling container and how it should be orientated when it is placed at the curb.

As each data or RFID tag packet is assembled by the manufacturer, a pre-assigned alphanumeric code, barcode, or another specifically designed code or image is printed on the outside of the completed package. This code is designed to specifically identify the name of the RFRCC it is assigned to plus the mailing address to which it will be delivered. For example, in an alpha numeric code, the alpha section of the code is assigned to the name of the RFRCC while the numeric section is used to identify each residential address within that RFRCC. However, the six digit numeric code may also be used to subdivide the RFRCC data by area or region, by day of collection, or in any number of ways that will be obvious to those skilled in the art.

The user database 24 contains a large number of data fields associated with the users of the RFRCC program. Included but not limited to, are such data as physical address, name, data or RFID tag number, the geo-location of the property, etc. The data to populate the various fields of the database is provided by the community or group that licenses the right to use the RFRCC program or recycling system, although some data such as the geo-codes may be obtained from third parties. Alternatively, the waste hauler that has been licensed to utilize the RFRCC system may provide the data. Once the database has been populated with the community unit data, it may be used to allocate and track the rewards for the RFRCC members in that community based upon their actual recycling participation as measured by the periodicity of each member's curbside set out.

If an RFRCC member records a recycling event on a periodic basis that is defined by the RFRCC (at least once per month) then the member is deemed to be an active recycler and the member is eligible to access both the Tier 1 and Tier 2 reward levels. In addition, active recyclers automatically qualify for a chance to win a special Tier 3 reward. This is a high value prize that is awarded to a specific member of the RFRCC or to a participating member of the public on a periodic basis. The winner(s) are determined by random drawing, or by the winner of a contest or competition, overseen by the local RFRMO. If a RFRCC member does not record any recycling events within a specific (four-week) period, they are deemed to be inactive recyclers. As such they are restricted to claiming only Tier 1 rewards on the RFRCC website and they do not automatically qualify for the Tier 3 prizes that are awarded periodically.

If you are an active recycler and miss setting out a RFID identified recycling container within the period defined by the RFRCC (for four or more weeks), you may retain your active status by contacting customer service at RFRCC and provide an explanation for the prolonged period of inactivity, and your active status may be reinstated. However, if a RFRCC member has a 60 day period of inactivity during which no recycling event log activity is recorded, they are automatically transferred to the inactive recycler status and must re-qualify to obtain active status.

The recycling event activity within an RFRCC can be documented using a variety of information gathering techniques. Most commonly used today is a vehicle on which is mounted a RFID reader system to register when the recycling container, with its unique RFID data tag, is placed at the curb 22. The reader system may be mounted on the recycling truck used by communities' waste collection service provider, or a RFRMO low emissions or electric tracking vehicle equipped with an onboard computer and RFID tag reading system. Each time a unique RFID tag is detected, the reader system records the event to the onboard computer which later uploads the RFID tag number, together with a time and date stamp to the RFRCC database 24. The uploading of this recycling event data prompts the database monitoring system to credit the user of that particular RFID tag with a recycling event.

The onboard computer processes the recorded data in real time and registers any multiple data tag reads as a single recycling event. At the end of each day, the onboard computer logs onto the RFRCC data network via the internet or by a number of alternate network access procedures, and downloads the RFID tag numbers and the associated time and date stamp to the appropriate RFRCC within the user database 24. As earlier stated, the information gathering techniques used are a function of the unique identifier attached to the recycling container.

However, instead of allocating an RFID tag to each member's recycling container, a specific geo-location is assigned to each member of the RFRCC and the geo-code assigned to each address has a defined geo-fence around it. This permits a ground positioning system (GPS) to determine if a specific recycling container is serviced by the pick-up vehicle, and/or by a service person wearing a GPS tracking device. In most cases, the recycling container is located by a GPS device, which is mounted on the recycling vehicle when it stops at a location and picks up the recycling container(s). However, if a number of recycling containers belonging to several RFRCC members are serviced when the recycling vehicle stops, then a second data collection set is used. In such cases, a second geo-locator carried by the vehicle operator is used to determine which of these multiple locations are serviced at each such multi-stop location. The GPS locations are recorded every second by the onboard computer and sorted into moving and stationary locations. The stationary points are compared to each member's geo-fenced location in the onboard database and recorded as active recycling events when they match. Once the list is complete, it can be stored and downloaded to the appropriate RFRCC within the user database 24 at a convenient time.

The invention also contemplates information gathering as a user based measurement system. This type of information gathering allows a single user, who has joined an RFRCC program to register his/her own recycling event 18. In addition, it can also be used by the active recycling members of a community RFRCC in which the hauler and the municipality have decided that the self-reporting of each recycling event is acceptable to the membership of that particular RFRCC.

The individual members of the program, who participate in a self-reporting event logging program are designated as members of the special section of the user group community that is designated as the My-R4R user group 26. As recited above, such groups of individuals are individually active recyclers or environmental activists who strongly believe in recycling. Since the My-R4R user group 26 may be geographically widespread, the use of a cell phone, or smart-phone, will allow these individuals, to report and record their recycling activity on an ongoing basis 18. The event logging procedure requires the user to locate the recycling container at a specific location, such as the end of a driveway and then use the phone's geo-sensing and media capabilities to generate a location specific photograph. The resulting picture which will also be time and date stamped is then sent to RFRCC data center where it is verified against the geo-code for that specific member.

Alternatively, if the phone does not have a geo-location system, the user can place a RFRCC sticker, or another clearly defined marker, on the recycling container, and send a date stamped picture to RFRCC data center 28 where the marker will be identified and used to update the members' recycling event database 24.

As a further alternative, the user can use an ordinary electronic camera to send a date and time stamped picture from a computer to the RFRCC database and obtain credit for each recycling event 18.

As the use of smart phones increases, these self-reporting users with such devices will be supplied with a phone specific application, or “app”, such as those popularized by the Apple iPhone. The smartphone “app” system will automate the whole event reporting system and further improve the process for self-reporting users. A self-reporting system may also be used by a community based RFRCC, if the membership together with the licensing authority, agree that self-reporting is an acceptable procedure for reporting recycling events within their particular RFRCC.

The invention also contemplates reporting a recycling event without verification. In this case, the user may be an individual member of the My-R4R user group 26 or part of a standard RFRCC unit and they are able to report a recycling event directly, by signing into their account and registering the recycling event 18 at their RFRCC website. In such cases, the RFRCC administrator at a local RFRMO may audit the self-reporting account on a random basis. This RFRMO auditing procedure may require that the recycling service provider verify recycling events at a statistically significant set of self-reporting addresses, or by using an RFRMO audit vehicle to perform the same function.

The data collected in the user database 24 is used to determine how the rewards available from the merchant groups 30 attached to each RFRCC are redeemed. The redemption information in the user database 24 contains a variety of information that is associated with the users and the reward they redeem. This data may be used to track ongoing retrievals by classification (food, beauty products, services, sports, and leisure, etc.), by member demographic information, by merchant name and type, by geographic locations, and many other classifications 44. This is achieved through the relational databases used to store user data 24 as well as merchant data 32.

The individual self-reporting members described above are either enrolled into the My-R4R group 26, which then provides rewards to individual members who are interested in recycling, or in a self-reporting RFRCC 18 whose rules allow for this type of recycling event logging procedure. In both cases, the individuals who are members of these RFRCC organizations are able to obtain rewards provided by a group of local merchants. However, in some cases, the merchants involved in the My-R4R are either direct sponsors 34 of this program, or regional/national merchants 36, 38, who wish to use this type of public space to make a statement in respect of their commitment to a greener business environment. In both cases self-reporting members are able to utilize these special recycling event recording systems to gain access to their own Tier 2 awards program. If they chose not to report recycling events they can still take advantage of the Tier 1 rewards that are posted on the My-R4R website.

Individual group members can be enrolled through any predetermined group of recyclers, environmental activists, or a variety of recruitment methods, but more generally they are enrolled by the providers of subscription based community wide recycling programs where there is no central authority to contract directly with RFRMO. The opportunity to become a My-R4R member, or to create a separate self-reporting RFRCC group, may be provided by a local or regional waste hauler contractor, who has licensed the program from RFRCC for the benefit of his customers, or by a regional 36 or national 38 merchant or group who wish to use this type of public space to demonstrate their commitment to a greener business environment, or by the communal or regional political leadership when funding is not available to fund a more technically sophisticated event logging procedure based on the actual collection process.

Once the license agreement is in place, the process of forming an RFRCC group begins with advertising, direct mail, and other media campaigns within the web and television marketing and promotion capabilities 40 of each RFRCC program. Such campaigns build anticipation within the community for the rewards program prior to its actual commencement. Once the group officially begins to sign up members 42 at the RFRCC website these members begin to participate in the RFRCC programs, and the associated TV promotions, radio spots, and other media programs are used to encourage every member of the RFRCC to become an active recycler.

The television spots used to recruit both individual members and groups of members are also used to enroll the merchants 44 that provide the rewards that are the basis of the incentive program that keeps building a better recycling community. It is possible to place a short merchant promotional spot within an RFRCC promotional advertising spot, which helps build interest from the user members and allows the merchant to advertise and promote his or her business. These merchant promotion spots, plus direct recruitment through community organizations such as the local chamber of commerce, ensures that the RFRCC is able to provide a wide range of high value rewards to a specific user group or community.

As the individual merchants that provide the rewards for a particular community are enrolled into the RFRCC program, they coalesce into a community merchant group 45 which provides its own special impetus for the program. In some cases, these merchant groups combine into regional merchant groups 36 that may offer rewards to several communities. This is particularly the case in suburban bedroom communities where there is a large residential population but no large local business community. In such a case, their RFRCC can utilize merchant groups from neighboring communities with vibrant small business communities. This type of program provides the merchants with access to a larger number of potential customers and the users with a greater number of rewards over a wider range of goods and services.

The final product 46, is a combined merchant group that is formed by consolidating the merchants from different RFRCC organizations into a combined RFRCC merchant group. This combination provides the merchant members from each RFRCC's within a particular region, with a large pool of potential customers. In addition, it allows these merchants to work in conjunction with their local RFRMO to leverage their combined purchasing power to provide television and other advertising services to each of these unitary small business entities.

Associated with the merchant and user group assemblies is a plurality of sponsors 34. These members of the RFRCC system are major businesses that may be either regional or national in nature, who want to use the positive exposure associated with a large recycling program to publicize the green credentials. Typical of such organizations are automobile manufacturers who can provide merchant groups through their dealer networks. The dealer groups can then support local RFRCC user groups by supporting special programs such as self-reporting systems or environmental programs or other types of special events in the RFRCC communities. The intent of the program is to limit the sponsorships to those companies with excellent environmental records or to those wishing to build an environmental program by supporting and promoting recycling efforts in the community.

The sponsor's program is designed to provide assistance to those user groups that are attempting to widen the scope of their community based RFRCC recycling program into other environmental programs that have a limited appeal in just one community but may find a large user group for a particular program if they can combine a number of local or regional RFRCC programs to form a new user group such as the Flint River Cleanup Group.

Another special subset of users is the junior rewards program 12. Junior rewards programs 12 are associated with most standard RFRCC organizations, including the My-R4R user group. These programs are most often formed in schools, sports and athletic clubs, at a dance studio, or in any other community organization where young people, between the ages of eight and eighteen congregate. In many cases, a junior RFRCC program will provide its own special rewards program which often has great appeal to a certain segment of the merchant community associated with the parent RFRCC. In almost every case, a number of the merchants that provide rewards for a particular group of young people are very active in the main community rewards program.

One of the main functions of the junior rewards program is to act as a conduit to those parents that are inactive recyclers. Consequently, the influence of the junior rewards program is a major component of the ongoing program whereby inactive members of an RFRCC are persuaded to become active members of their recycling program. In many cases, if there are children in the house, they will bring the junior rewards program home because they are able to assign active recycling events recorded at their home address to earn credits for their junior recycling program at their school or other affiliated organization. The junior rewards program is also a good source of self-reporting members to the My-R4R organization, as this particular demographic tends to be much more adept at using the technology that supports the self-reporting data acquisition systems this program is based upon.

The merchant database 32 contains the information about each merchant in the RFRCC program. Typical data entries are name, address, business classification, community base, merchant group, if any, coupons issued, coupons redeemed with date and time stamp, number of each coupon redeemed, data for members claiming each coupon, and references to member data base demographics. It contains references to merchants that purchase television and advertising time, and other types of promotional programming that may be used to promote the objectives of the RFRCC.

A merchant may post a rewards coupon on the RFRCC website 28 for every community he is allowed to service. The rewards coupon may be placed in the Tier 1 or Tier 2 rewards section of the user website per the prior approval of the appropriate RFRMO. The rewards coupon, which will be designated by business type, such as fast-food/snacks, restaurants, health and beauty aids, services, sports and recreation, etc. will be available to any qualified member of that merchant RFRCC. As reward coupons are redeemed they will be recorded in the user database 24 as a redemption record for each claiming member/user. The same transaction, without the appropriate customer demographic data, is also recorded in the merchant database 32. The data is recorded in both databases, but the information in one is not available to the other 48. In the merchant database 32 only the types and frequency of posting and redemption of rewards will be recorded to allow the merchants to review and utilize this data to best determine which offers are most productive in promoting their business. The detailed demographic data from the user side of the user database 24 is kept for the sole use of RFRCC and this data is only available to the merchants if they pay RFRCC for information and advertising services 48. However, as shown in FIG. 1, the data derived from the data mining systems employed by RFRCC are directly available to the regional and national sponsors 36, 38 as this data transfer service is included as a part of their sponsorship agreement.

All the merchants are allowed to post reward coupons to the website as often and in whatever quantity they wish once they have been approved as to look and content, but they cannot exceed their preset limit of coupon space on the website. As the popularity of the website for each RFRCC increases, the ability to place coupons on the premium sections of each reward page becomes limited. In such cases, the merchants are able to purchase the premium spaces on each page from the local RFRMO. However, a certain portion of premium coupon space on each RFRCC web site is reserved for original members of the merchant community. This ensures that late corners, with deep pockets, are not able to dominate a particular class of rewards by buying up all the coupon space. In every case, the merchants are able to review the effectiveness of each posting and may withdraw and replace coupons as and when they wish. The merchants are able to determine how many coupons are redeemed, who has claimed them, and how many are actually presented at their place of business.

In some cases, the claim mechanisms may be electronic, where the coupons are delivered to cell phones or smart phones by a phone specific RFRCC application program and then redeemed at the merchant's place of business. In such case, the feedback mechanism for the merchant is much more immediate. In the latest version of the rewards system, a member may access the RFRCC rewards listing when they are physically present in the merchant(s) area of the community. They may access the local RFRCC rewards by using a phone specific RFRCC application on their smart-phone that contains a geo-positioning sensing system, which allows them to review what rewards are available within a specific distance or local geographical area. Once the user chooses a specific reward offered by an RFRCC merchant, the redemption coupon is delivered to the user's phone, which they can take to the merchant to redeem their reward.

In a pending version of the smart phone, the rewards redemption system within the application will prioritize the merchants shown to the user based on proximity, value, and advertising priority. This system will utilize the next version iPhone operating system, which will provide an iPhone application developer with the ability to embed advertisements within the rewards coupon that are displayed when the phone application is initialized within a certain geographic region of a specific RFRCC community.

The user 24 and merchant 32 data base may be used by the RRFMO to aggregate the value of the rewards that are redeemed by the members of a specific RFRCC. This aggregated data can be reported to the decision makers in each community, or posted on the RFRCC website, to demonstrate the value that has been delivered to those residents that are actually using their RFRCC program. This allows the decision makers to pass this information to all their residents, or for all users to see it for themselves, as in many cases the cost savings derived by the active members may encourage the inactive members of the RFRCC to become active participants in the program.

FIGS. 2 and 3 are schematic representations of a typical networked environment in which the above-described recycling system and method of invention may be implemented. In the preferred embodiment, the environment in which the system and method of invention will run consists of a server 56 that communicates via a communication channel 58 with a distributed computer network (DCN) 60.

The DCN 60 will preferably contain a client tier 62 that is defined by a plurality of individual networked terminals, workstations, or computers 62a-62e. The DCN 60 consists of any combination of a number of network systems. For example, it may consist of a combination of local area networks (LAN), wide area networks (WAN), intranets, and the internet itself. The preferred embodiment makes use of the internet due to the internet's wide adoption and familiar interface.

The set of client tier computers 62a-62e are associated with individual users of the present invention and method of the invention. The number of computers in the diagram is not intended to represent any limit on the number of real or potential members of the RFRCC that are able to utilize the system.

Other users of the present invention who are not members of an RFRCC, are also provided with access to the DCN. These users include administrators, agents, staff, and assistants of the recycling/waste collection company who are responsible for the event logging processes that determines when an RFRCC member obtains credit for a recycling event. In addition, administrators, agents, staff, and assistants at each of the Rewards for Recycling Central Management Offices (RFRMO's) have access to the DCN. A third set of external users who are also able to access the DCN are specific third parties who are associated with the recycling/waste collection company, or a RFRMO.

It is envisioned that many different configurations of the client computers 62a-62e may provide the required performance, reliability, and consistency necessary for the system and method of the invention. In one embodiment, which is an exemplary one, the computers 62a-62e may include a Pentium processor above 400 MHz with 512 MB RAM, a 56K modem, a video monitor with at least 800 by 600 pixels, and 16 bit color palette. Further, the example computer 62a-62e is running Windows XP or Windows 7, with Microsoft Internet Explorer 6.0 or higher, with JavaScript enabled.

Multiple users may share the same computer and a multiplicity of users can use the invention at the same time from the same or a variety of locations. The computers in the client tier consisting of computers 62a-626e, allows users to communicate with and access data on the server 56 through the DCN 60 and the communication channels 58. The communication channels 58, whether wired or wireless, are well known and therefore not further described herein. It is also envisioned that users can communicate with the server 56 by a direct connection to the server.

Additionally, the server 56 hosts multiple databases 54, business objects, and websites that can be characterized as a data tier 64, a business tier 66 partially defined by email and fax servers 68a, 68b, and a web tier 68. It is envisioned that the preferred configuration of the server 56 will consist of one or more (multiple) servers, as necessary, to achieve the desired performance from the server 56. Multiple servers can be linked in such a way so as to provide for greater stability and performance of the present invention through the distribution of processing and memory.

Referring now to FIG. 3, there is illustrated a representation of the preferred embodiment of present invention. The data tier 64 runs a database server 70 and hosts a plurality of databases 64. The business tier 66 includes a business server 72, stored procedures 74 within the databases 64, and ActiveX COM+ objects 76 that make use of those stored procedures 74. The business tier 66 contains the core data functions of the system that retrieve requested data and update the existing data. The business tier 66 also receives data into the system via the email 68a and fax servers 68b, which may also be integrated within the business server 72 itself or separate therefrom, as shown in the figure.

In the preferred embodiment, the client tier 62 utilizes a browser 78, preferably Microsoft's Internet Explorer. The client tier 62 sends Hypertext Transfer Protocol (HTTP) requests 80 to the web tier 68. A web server 82 processes those requests 80 and returns appropriate ASP pages 84. After processing the ASP pages 84, the web tier 68 returns to the client tier 62 the necessary information for the browser 78 on the client tier 62 to create the visual interface for the user.

In a preferred embodiment, the architecture of the server 56 consists of multiple servers in order to increase stability and enhance performance. For example, each server which comprises server 56 would consist of a PENTIUM™ 4 2.5 GHz processor from Intel Corporation, a minimum of 2.5 GB RAM and sufficient hard disk non-volatile memory, to support the web files, a server based operating system, several applications and several relational databases 64. Preferably WINDOWS 2003™ software (available from Microsoft Corporation) is the server operating system. It is envisioned that the websites are created in HTML language utilizing VISUAL STUDIO™ software version 6.0 or later (available from Microsoft Corporation) and remote access is facilitated by Microsoft's Remote Desktop Connection and GlobalSCAPE's CuteFTP Ver 2.8 file transfer system. The database engine used by the present invention is Microsoft's Essential Business Server 2008 software from Microsoft Corporation, which is also used to maintain relationship diagrams for the various databases 64 of the present invention. Microsoft's Essential Business Server 2008™ allows developers to customize the websites for machines that run this server software.

Still referring to FIG. 3, in a preferred embodiment the server 56 is configured as a combination of three servers, two of which are configured with a Pentium™ 4 2.5 GHz with 2.5 GB RAM, a hard disk large enough to support web files, and an operating system such as Windows 2003, while the third server machine which is configured with a PENTIUM™ Pro 200 with 256 MB RAM, and a hard disk large enough to support an Enterprise Fax Manager and an operating system such as Windows 2003. The first server, such as the data server 70, associated with server 56 runs a Microsoft SQL Server 2008™ installation for housing multiple databases 64 including, without limitation, the present invention, and other smaller databases. The second server, such as the web server 82, which is associated with server 56, runs Microsoft Internet Information Server 5.0™ to store the ASP pages 84 together with any HTML pages, and processes the HTTP requests 80. The third server such as the business server 72, associated with server 56 receives and processes fax and email documents into the system of the present invention. In yet another embodiment, additional servers may be incorporated into server 56 to further increase performance and stability.

It is envisioned that standard development tools will be used in conjunction with the present invention and method of invention. For example, in the preferred embodiment Microsoft SQL Server 2005 Enterprise Manager can be used for the development and maintenance of the databases 64 and stored procedures 74. Microsoft Visual Studio 2005 or Microsoft Visual Basic 6.0 can be used for the creation and compiling of the ActiveX COM+ objects 76. Microsoft Visual Interdev 6.0 may be used for the development of HTML and ASP web pages 80 and 84 within the application. GlobeSCAPE's CuteFTP 2.8 may be utilized to distribute the various ActiveX COM+ objects 76 and web pages 80 and 84 to the proper locations on the server.

Further examples include Adobe Acrobat version 7.0 and Adobe Distiller 5.0 for creating manuals that may be made available from within the present invention.

In the system and method of the invention, the databases 64 will be able to interact with an email system 68a. In a preferred embodiment, Microsoft SQL Server 2005, which contains the stored procedures, will be used to interact with a mail application program interface (MAPI) compliant email server. In a preferred embodiment, the email server that is contained within Microsoft Outlook 2007 is such a mail server. These tools are used to bring documents into the system via email.

Another example includes Right-Fax Enterprise Fax Manager Version 8.5 for processing incoming faxes. The faxes are made available to a process within the scope of this invention that is described herein further below.

Still further examples include Microsoft's XML Parser 3.0 which includes a component that can be used to retrieve the resulting HTML code of web pages, given a web page Uniform Resource Locator (URL).

The data architecture supports a database server, database connectivity, data conversion, data archiving and auditing capabilities. The database server preferably utilizes Microsoft SQL Server 2005 as the database engine for the present invention. Microsoft's Active Data Objects (ADO) version 2.8 is used to establish database connectivity between business objects and the databases. Preferably the Open Data Base Connectivity Data Source Name (ODBC-DSN) parameters including name and password are maintained within a database connection business object. SQL Server Enterprise Manager and SQL Server Query Analyzer are used for maintaining a data dictionary, primary and foreign key definitions, triggers, and stored procedures.

Data conversions can automatically reformat existing data in external formats such as Microsoft Access and Microsoft Excel for compatibility with the present invention and method. Alternatively, any requisite data conversions can utilize manual re-entry for all current listing data.

It is noted that while the exemplary description herein refers to specific individual databases, formats, records, and fields, those skilled in the art will readily appreciate that various modifications and substitutions may be made thereto without departing from the spirit and scope of the present invention.

The security context of users for the RFRCC and RFRMO users are configured based on several criteria and can be modified from ASP page to ASP page. Some pages that relate to marketing aspects of the recycling program and method of the invention do not require any level of permission. Other portions of the recycling program require the user to log in, and the level of access granted is determined by the user's relationship to the owner of the data. Tokens are created and assigned to users at different junctures to track the user's identity, the user's relationship to data owners, and the user's participation in given recycling transactions as determined by their RFRCC. These tokens are used in conjunction with business rules in the requested ASP web page to determine which business objects are used and what data is visible to the user.

Preferably the present invention and method of the invention will use a role-based security method. When access is established for a given user, a recognized role within the system is assigned to the user. In addition, RFRMO administrators and an RFRCC's agent can assign specific users, within given roles, a participatory role in a given recycling activity.

In a preferred embodiment, there are three key aspects considered within the security model as follows: (i) user identification/authorization and tokenization; (ii) determining a user's relationship to the data owner; (iii) and determining the user's participatory role in the recycling activity. A combination of custom security components, database tables, and application logic is used to tokenize a user and determine permission levels.

The Active Server Page (ASP) application is configured to allow anonymous access. This allows anyone to request any ASP web page. However, most ASP web pages additionally check to see if the user has the proper tokens. Without the proper tokens, the user is redirected to a login ASP web page. The few pages that do not require tokens are marketing pages that provide information to existing and new users of the present invention.

At an ASP web page that contains a login option, the user must enter a set of credentials such as username or radio frequency identification device (RFID) tag number, together with a password that will uniquely identify the user within the system environment. Alternatively, if a user has never been on the site before, that is, they are a new user that may login by entering their name, street address, and an email address. The system will then check to see if such user and address exists. If it does, the new user will be informed that a one-time user password will be sent to the email address they have entered, which they are to use to enter the site for the first time. Once they use this password to enter the site, they will be prompted to enter a new user defined password, which will allow them to return to the site on a regular basis. This login procedure may be used for all new users or just for those members that have not been issued an RFID tag, as they are self-reporting or My-R4R members.

The username or RFID tag number together with a password are passed to a business tier object that looks for matching username or RFID tag number and password information in the user database. If the combined username or RFID tag number and password is not found in the user database, authentication is terminated and a resulting message is passed to the web tier. The web tier then provides a visual message to the client tier machine informing the user of the rejected login and provides an opportunity for the user to log in again.

If the combined username or RFID tag number and password are located in the user database, the user is authenticated and the following tokens are created: (i) a token representing the user's unique ID within the system environment; (ii) tokens representing the user's relationship to an RFRCC community unit and agent; and (iii) a token representing the user's role. An exemplary method for creating the tokens is to create them as session variables within the Internet Security System/Activity Server Page or (ISS/ASP) framework. An additional exemplary method is to create a unique ID for the user session, and use the unique ID as a key into a database that contains the token values for that user session.

The tokens are time sensitive, based on the configuration of time parameters within the web tier, and expire after a certain period of inactivity by the user. In the preferred embodiment, the time period is set but not limited to 60 minutes.

If the tokens do not exist, either because they were never created or because they have expired, the next HTTP request from the user will be handled as if the user had never been authenticated. In such a case, the web tier will provide a visual message to the client tier, informing the user that no authenticated login exists and will provide an opportunity for the user to log in again.

After the user is authenticated and tokenized, the user is allowed into the present invention. The tokens are used in the web tier to determine which RFRCC visual interface will be provided to the client tier.

Once a user has been authenticated and tokenized, the security model follows two branches. The first one applies to a user that is a member of an RFRCC as such they are granted access to their user information, recycling events, and the appropriate tier of the rewards database. However, a user with the assigned role of member or user does not have the authority to add new recycling groups to the present invention, or administer any other housekeeping functions. In the second case, the user's role will be dependent upon the user's relationship to the data owner, and the user's assigned participation level within the recycling activities. In almost every case, the second class of user will be an employee or an associate of a Reward for Recycling Management Office or RFRMO unit. For example, an RFRMO based user, with the assigned role of “agent” can enter a recycling event when a self-reporting member sends in a camera picture with a date and time stamp. In another example, a user with the assigned role of “merchant” can only view system activity that relates to the redemption and provision of rewards provided by that particular merchant including the posting of new and the removal of old rewards provided by that particular merchant.

It is envisioned that several roles will be defined for a user, one level for an RFRCC member, and a variety of roles assigned to people in an RFRMO, who interact with the management and control sections of the recycling program, however, additional roles may be added in the future.

At a minimum, the following roles are defined. Administrators are users who manage the recycling program, who own the technology of the recycle program or those who are licensed to practice the recycling program, each of which will control one or more RFRMO's. Agents are responsible for the operation of one RFRMO and have authority to act on the administrator's behalf within that office. Agents are also those in the field responsible for obtaining new client groups who need to acquire a license from Rewards for Recycling and form an RFRCC with the intention of practicing the recycling program of the invention. In addition, agents can work with waste collection and recycling contractors who may wish to license the recycling system, to increase the number of customers in their waste collection network. Administrators, by virtue of their authority and credentials, may also act as agents and assistant staff members. Staff members help administrators with their clerical duties, although, assistants may also be hired by agents to assist in clerical duties. Third parties may also participate in the recycling activity when they need to access certain information related to a specific business function or transaction, but otherwise they will work outside of the scope of the present invention and method of invention. These third parties include (but are not limited to) attorneys, contract haulers, sign companies, municipalities, advertising companies, merchants, sponsors, and insurance companies.

An additional role of system administrator also exists, but is separate from the user types. This is based on a flag that is set within the users table. Any user could be assigned as a system administrator. However, this is typically reserved for those skilled in the art and with the technical knowledge to understand the effect of various configuration changes upon the present invention.

Security maintenance is provided from within the present invention and method. System administrators can enter data to support new merchants and community groups. A system administrator, or his agent, can grant or remove access for any user within the administrator's or agent's sphere of influence. This would include staff, assistants, clients, and client groups. For agents this includes a given agent's clients, client groups, and assistants. Third parties may also be granted access to recycling information within the administrator's authority or be cut off from those listings as the administrator sees fit.

An additional security function is provided to users assigned to the role of administrators (or administrator's staff) allowing the administrator to masquerade as one of the users under the administrator's realm of influence (agents, staff, assistants, and clients). This allows the administrator to understand what is visible to users that are assigned other roles, and allows the administrator to process clerical work for others if necessary.

To access the security function, the administrator proceeds to a visual interface where the administrator is presented a list of users as whom the administrator is allowed to masque. Upon selecting one of the presented users, the administrator is presented a visual interface as if the user being masqueraded had just logged on. The administrator has the option at any point in time to change the masquerade to another user or to turn off the masquerade function and continue as his or her own self.

The act of starting and ending a masquerade session, along with any data modifying action, is captured and maintained in an audit file. Thus, one user can act as another, but the present invention tracks such usage.

In the preferred embodiment, the memory of the database server stores a multiplicity of databases. It is envisioned that the databases are created utilizing Microsoft SQL Server 2005™ from Microsoft Corporation. The databases contain data relating to users, recycling activities, recycling features, third party companies, audits, and documents.

It is envisioned that the user relational databases contain information regarding all people who have or may need access into the present invention including (but not limited to) name, address(es), phone number(s), email address(es), company affiliation, community group affiliation, login credentials, remarks, and schedule. Recycling activity databases will preferably consist of property address, user and group information, photographs and image file locations, documents and document file locations, recycling advertisement information, and associated third party contacts. Merchant databases will preferably consist of information regarding various third party companies with whom the administrator has made an agreement to supply the Tier 1 and Tier 2 level rewards to one or more RFRCC organizations. This data can include (but is not limited to) company name, address(es), phone number(s), email address(es), company type (role), and user affiliations. Digital document management (DDM) databases preferably consist of information related to the inbound processing, storage, relationship, and management of digital documents. Audit databases preferably consist of information regarding various auditable events happening in the present invention including (but not limit to) user login and logout, masquerade start and end, creating entry of data, sending of automatic emails, and viewing of recycling-related documents as well as audits used to certify self-reporting members.

In a preferred embodiment, the databases are used in a relational arrangement so that they relate to one another by way of fields that store common data. Audit trail records are generated by the present invention as users go about their tasks within the present invention. Often those tasks will be related to a listing within the system. Sometimes those tasks will be related to viewing or emailing a document attached to a listing. Audit trail records are available for reporting purposes as related to a specific user, or as related to a specific recycling activity.

Documents are predefined and entered by system administrators. For example, document types might include “Word Document”, “Excel Spreadsheet”, “Adobe Acrobat”, or “Other”. When a document is added to the present invention, the document is stored in a document storage area on the server, and an entry is created in documents table that includes both the network address of the document, and a reference to the RFID tag, and/or to the user name and address to which the document is associated. Fax processing is a record of the faxes sent to the present invention. Mailstore is a temporary storage location used in the process of taking documents that have been emailed to the present invention and attaching those documents to listings.

While the present invention has been described in terms of a limited number of embodiments, it is apparent that other forms could be adopted by one skilled in the art. In other words, claim elements are not limited to the imperfections of the exact language used, but encompass as well other structure that fulfills the same functional purpose. In other words, the teachings of the present invention encompass any reasonable substitutions or equivalents of claim limitations. Those skilled in the art will appreciate that other applications, including those outside of the recycling industry, are possible with this invention. Accordingly, the scope of the present invention is to be limited only by the following claims.

What is claimed is:

1. A method for automating various phases of a recycling program, said method being centralized on at least one server and carried out over a distributed computer network to a plurality of client computers, said method comprising the steps of:
establishing a recycling for rewards community club unit having users in defined group members;
creating a recycling record for each user in each of said defined group members;
receiving information from a plurality of sources including computer input devices, user databases, facsimile equipment, and electronic mail systems;
associating at least some of said information to said recycling record using a recycling identifier associated with said recycling record; and storing said received information on said at least one server in association with said recycling record.

2. (canceled)

3. (canceled)

4. (canceled)

5. (canceled)

6. (canceled)

7. (canceled)

8. (canceled)

9. (canceled)

10. (canceled)

11. (canceled)

12. The method as claimed in claim 1 wherein said establishing step formed users into said defined group members in order to enable the use of concepts of group members to encourage and direct said defined group members into maintaining and increasing their participation in said recycling program.

13. The method as claimed in claim 1 wherein said defined group members further comprises active as well as inactive members.

14. The method as claimed in claim 1 wherein said creating a recycling record step further comprises recording a recycling event into said recycling record whenever an active participant performs the recycling activity.

15. The method as claimed in claim 1 further comprising attaching said record identifier to a container designated for collecting recyclable waste.

16. The method as claimed in claim 15 wherein said recording a recycling event further comprises a remote monitoring system for reading said record identifier when said container is standing curbside.

17. The method as claimed in claim 15 wherein said recording a recycling event further comprises a local monitoring system for reading said record identifier when said container is standing curbside.

18. The method as claimed in claim 15 wherein said recording a recycling event further comprises a client device that can communicate a recycling event notice to a client server.

19. The method as claimed in claim 1 further comprising offering a plurality of rewards to each member of said defined group members for visiting the website of said recycling for rewards community club so as to encourage all of the members of said defined group members to participate and encourage each member to recycle a portion of their own waste on a regular basis.

20. The method as claimed in claim 19 wherein said plurality of offered rewards are of a higher value and offers only to active participants who record a recycling event into said recording record on a regular basis.

21. The automated recycling method as claimed in claim 1 wherein said receiving step includes an administrator's agent reviewing said information and granting viewing rights to authenticated users, such that said authenticated users can access and view a digital representation of said information.

22. The automated recycling method as claimed in claim 1 wherein said associating step further comprises:
determining whether said record identifier matches any of a number of a plurality of recycling rewards;
discarding said received information if said determining step is negative.

23. The automated recycling method as claimed in claim 1, wherein said associating step further comprises:
determining whether said record identifier matches any of a number of plurality of recycling records; and
saving said information on said at least one server in accord with a matching record identifier if said determining step is positive.

24. The automated recycling method as claimed in claim 1 wherein said receiving step comprises:
receiving a fax communication from any fax source capable of contacting said at least one server; and
converting said fax communication into a digital document that represents said information to be associated and stored in accord with said associating and storing steps.

25. The automated recycling method as claimed in claim 1 further comprising the step of providing security clearance and access over said distributed computer network to at least some portion of said recycling record to a plurality of different users depending upon an assigned role of a user among said plurality of different users, said plurality of different users including administrators, agents, employees, user members, third parties, and the like.

26. The automated recycling method as claimed in claim 1 further comprising the step of providing a masquerade function whereby one of said plurality of different users can masquerade as another of said plurality of different users.

27. The automated recycling method as claimed in claim 1 further comprising the step of tracking activity on said at least one server so as to provide an audit trail of said activity corresponding to said recycling record such as date of access, user identification, and the like.

28. The automated recycling method as claimed in claim 1 wherein said method is administered by a recycling administrator.

29. The automated recycling method as claimed in claim 1 further comprising the step of automatically generating email communications to one or more of said plurality of users based on the occurrence of an event.

30. The automated recycling method as claimed in claim 1 further comprising the step of generating reports from said recycling record.
